(19) United States
(12) Patent Application Publication
(10) Pub. No.: US 2010/0199477 A1
(43) Pub. Date: Aug. 12, 2010

(54) TOOL FOR DUST CAP REMOVAL/REPLACEMENT AND OPTICAL CLEANER EXTENDER

(75) Inventor: Stanley A. Mercado, Santa Clara, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignee: TASEON INC., San Jose, CA (US)

(21) Appl. No.: 12/368,197

(22) Filed: Feb. 9, 2009

(51) Int. Cl. B23P 19/04

(52) U.S. Cl. 29/278; 29/280

(57) ABSTRACT

A tool for dust cap removal/replacement and optical cleaner extender is described herein. According to one embodiment, a tool includes an elongate body having a frontend, a backend, and a tip member attached to the frontend of the elongate body, the tip member having a locking mechanism. When the tip member is pushed against a dust cap covering an optical connector mounted on a backplane of a network chassis, the locking mechanism interlocks with the dust cap thereby capturing the dust cap for removing the dust cap from the optical connector. The elongate body is long enough such that the tip member can be inserted into a slot of the network chassis from a front panel to reach the dust cap of the optical connector mounted on the backplane of the network chassis, without having to remove an adjacent circuit pack of the network chassis.

### FIELD OF THE INVENTION

The present invention relates generally to optical networks. More particularly, this invention relates to a tool for dust cap removal/replacement and optical cleaner extender.

### BACKGROUND

Fiber optic systems are getting more popular recently. With the advent of light-wave technology, a large amount of information is capable of being transmitted, routed and disseminated across great distances at a high rate over communication lines made of optical fibers which are coupled with each other through optical connectors.

Dust, dirt and other contaminants are a problem in such optical connections because they interfere with the passage of light from one fiber to another. Fiber optic connectors must be kept clean to ensure long life and to minimize transmission loss and optical return loss at the connection point. A single dust particle caught between two connectors will cause significant signal loss.

Typically, if an optical connector is not being used in a backplane chassis (e.g., a circuit pack module not being inserted), a dust cap is needed to cover the optical connector to avoid the dust or dirt accumulated thereon. In order to remove or replace a dust cap, a typical method is to use long tweezers to remove or replace the dust cap from an optical connector. However, such a method is often cumbersome due to the limited space provided by the chassis depth and the adjacent circuit pack modules.

In addition, optical connectors on a backplane are difficult to clean for several reasons. One reason is because the equipment housing the backplane and optical connectors is generally placed against a wall making access to the rear of the optical connectors difficult. Also, the optical connectors are small and difficult to handle when removed for cleaning so it is advantageous to be able to leave them in the system and clean the optical connectors via front access to the shelf. Another reason is that cleaning the optical connectors via front creates the possibility of contact with other system components causing catastrophic failure of the system.

Conventional methods require the removal of adjacent circuit pack modules to create space for the operator to reach the optical connectors on the backplane. However, removal of adjacent circuit pack modules may prevent the system node from operating partially or even completely. In addition, removing, rotating, and replacing the cleaning adapters individually could be a cumbersome process if the backplane has many optical connectors.

Another conventional method requires extending an optical cleaner by holding the cleaner handle at the rear end with fingertips of a user. However, holding the optical cleaner handle at the very end with fingertips in order to extend it requires good dexterity. It is difficult to keep the cleaner steady and in line with the optical backplane connectors.

There has been a lack of simple and reliable solutions for removing/replacing a dust cap of optical connectors and/or extending a cleaner for cleaning optical connectors inside a backplane chassis where the connectors are not easily accessible, while allowing other components to continue operating.

### SUMMARY OF THE DESCRIPTION

A tool for dust cap removal/replacement and optical cleaner extender is described herein. According to one embodiment, a tool includes an elongate body having a frontend, a backend, and a tip member attached to the frontend of the elongate body, the tip member having a locking mechanism. When the tip member is pushed against a dust cap covering an optical connector mounted on a backplane of a network chassis, the locking mechanism interlocks with the dust cap thereby capturing the dust cap for removing the dust cap from the optical connector. The elongate body is long enough such that the tip member can be inserted into a slot of the network chassis from a front panel to reach the dust cap of the optical connector mounted on the backplane of the network chassis, without having to remove an adjacent circuit pack of the network chassis.

Other features of the present invention will be apparent from the accompanying drawings and from the detailed description which follows.

### BRIEF DESCRIPTION OF THE DRAWINGS

The present invention is illustrated by way of example and not limitation in the figures of the accompanying drawings in which like references indicate similar elements.

FIG. 1 shows a configuration in which a tool is designed to remove and replace a dust cap of an optical connector according to one embodiment.

FIGS. 2A-2D show different views of a tool for removing/replacing and an extender for cleaner according to one embodiment of the invention.

FIG. 3 shows a perspective view of a tip portion of a tool for removing/replacing and an extender for cleaner according to one embodiment of the invention.

FIG. 4 shows a dust cap which may be used with an embodiment of the invention.

FIGS. 5A-5B show a tool in a process of removing a dust cap according to one embodiment of the invention.

FIG. 6 shows a tool in a process of replacing a dust cap according to one embodiment of the invention.

FIG. 7 shows a configuration in which a tool for dust cap removal or replacement can also be used as a cleaner extender according to one embodiment of the invention.

FIG. 8 shows a locking mechanism to extend a cleaner tool using a tool for dust cap removal and replacement according to one embodiment of the invention.

### DETAILED DESCRIPTION

A tool for dust cap removal/replacement and optical cleaner extender is described herein. In the following description, numerous details are set forth to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment.

In most fiber systems, dust and other contaminants are not a major problem as long as the “light”, that is the optical signal, remains within the optical fiber. However, problems arise when the optical signal must pass from one fiber to another or where the optical signal must leave the fiber and enter a receiver or piece of test equipment, such as an optical power meter. The most common mechanical arrangement to allow light to travel from one fiber to another is an optical connector. Fiber optic connector systems are designed to align two fiber ends so that the light signal will pass between them.

Most connector systems restrain the two fibers to be coupled within precision ferrules, which in turn are held in place by a housing. Within the housing, a precision alignment sleeve aligns the two ferrules and thus the two fibers. The fiber ends are flush with the ferrule ends and are polished to reduce loss of light. Most modern connector designs involve physical contact between the two fiber ends.

As mentioned above, dust, dirt and other contaminants are a problem in such optical connections because they interfere with the passage of light from one fiber to another. Fiber optic connectors must be kept clean to ensure long life and to minimize transmission loss and optical return loss at the connection point. A single dust particle caught between two connectors will cause significant signal loss.

In order to avoid problems and to keep fiber ends in peak condition, connector cleaning must be undertaken frequently. Inspection of the fiber end quality also needs to be undertaken to determine if cleaning is required or if the connector is seriously damaged.

The two basic approaches to cleaning are wet and dry cleaning. Wet cleaning utilizes a solvent such as Isopropyl Alcohol and fiber optic swabs. The swabs have a head made of a soft nonabrasive material that has low particle and fiber generation. Dry cleaning takes a number of forms, but the most common approach involves a special alcohol-free cloth or textile cleaning tape or film on a reel inside a cartridge. The cartridge stores the tape reel and provides a window onto a short portion of the cloth tape for cleaning the fiber ends of connectors. Also, a fiber optical swab with a sticky or tacky head may be used. Dynamic cleaning devices are also available which “spin” a cleaning cloth across the end of the fiber.

Microscopic inspection must be conducted to confirm that cleaning is successful. On some occasions, even after repeated cleaning, inspection will show that the fiber end is damaged beyond recovery and the connector must be replaced.

As mentioned above, optical connectors on a backplane are difficult to clean for several reasons. A backplane is an electronic circuit board containing circuitry and sockets into which additional electronic devices on other circuit boards or cards can be plugged. One reason is because the equipment housing the backplane and optical connectors is generally placed against a wall making access to the rear of the optical connectors difficult. Also, the optical connectors are small and difficult to handle when removed for cleaning so it is advantageous to be able to leave them in the system and clean the optical connectors via front access to the shelf. Another reason is that cleaning the optical connectors via front creates the possibility of contact with other system components causing catastrophic failure of the system. Another reason is that once the cleaning process is complete, all the fiber ends in the bundle must be clean. Furthermore, due to the small scale of the optical connector, finding the correct position for the cleaning swab or inspection scope while viewing the backplane from the front is very difficult.

Furthermore, when an optical connector is not in use, for example, when a corresponding circuit pack is not inserted into the corresponding slot, a dust cap is used to cover the optical connector on the backplane in order to prevent dust from being accumulated. As discussed above, it is difficult from a frontend of the chassis to remove and/or replace a dust cap from an optical connector mounted on a backplane of a chassis without removing the adjacent circuit packs given the limited space in between.

Thus, the purpose of embodiments of the invention is to allow a user to remove and/or replace a dust cap of an optical connector from a backplane and/or to clean the optical connector from the front of the chassis without having to remove an adjacent circuit pack. In one embodiment, a tool is designed to allow an entry into a tight space where there is a limited accessibility. Embodiments of the invention ease the process of removing and/or replacing a dust cap of a backplane optical connector for cleaning purposes and for connector deployment. Such a process can be performed without having to remove adjacent circuit packs from the chassis.

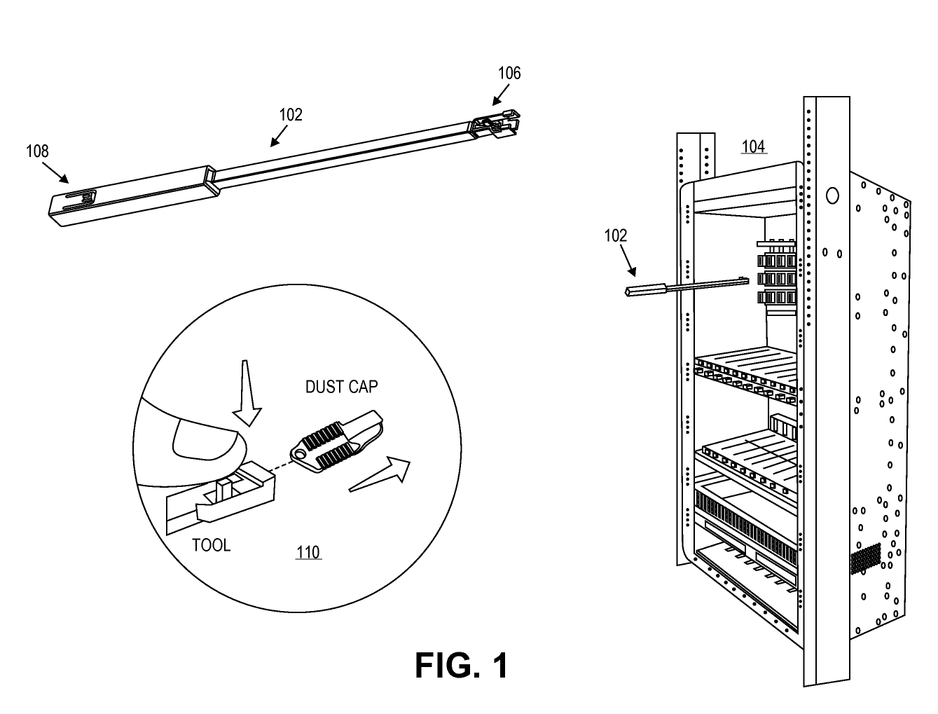

FIG. 1 shows a configuration in which a tool is designed to remove and replace a dust cap of an optical connector according to one embodiment. Referring to FIG. 1, a tool 102 having an elongate body with a tip member or front portion 106 and a back portion 108. The tip portion 106 includes a unique design that can easily capture a dust cap of an optical connector mounted on a backplane of a network chassis 104 for the purpose of removing or replacing the dust cap. In addition, backend 108 is designed to easily attach an optical dry cleaning device to extend its reach from the front of chassis 104 to reach an optical connector mounted on the backplane of chassis 104. Note that for the purpose of illustration, certain circuit packs have been removed from chassis 104 in FIG. 1 in order not to unnecessarily obscure embodiments of the invention. However, in practice, tool 102 can be inserted into any slot to reach a dust cap or to clean an optical connector without having to remove the adjacent circuit packs.

According to one embodiment, tip portion 106 of tool 102 is designed to relatively conform to a shape of a dust cap and is able to capture the dust cap when the tool is pushed against the dust cap. The tip portion 106 includes a snap feature (e.g., a snap button or tab), as part of a locking mechanism, to lock the dust cap in place. Tip portion 106 further includes a release button to disengage the dust cap from the tip portion 106 upon retrieval as shown in an enlarged view 110. Tool 102 can also be used to replace the dust cap by inverting tool 102 in 180 degrees with respect to its axis along the elongate body and placing the dust cap into tip portion 106 of tool 102. The tool 102 with the dust cap carried by tip portion 106 is then pushed against the backplane optical connector to insert the dust cap back into the optical connector. Backend 108 of tool 102 is designed to be attachable, via a locking mechanism disposed on backend 108, to a backend of a cleaner tool such as a MU/LC optical dry cleaner handle to extend the reach of the cleaner to the backplane for cleaning purposes.

According to one embodiment, to remove a dust cap from an optical connector, such as a duplex F-3000 connector from Accoppiatore, tool 102 is inserted into a slot of chassis 104 until tip potion 106 of tool 102 reach a dust cap. The tool 102 is then pushed against the dust cap until a locking mechanism of tip portion 106 interlocks with the dust cap. Once the tip portion 106 interlocks with the dust cap, the tool 102 can be pulled out which captures and carries the dust cap from the optical connector. The dust cap can then be disengaged from the tip portion 106 by pressing a release button disposed on the tip portion 106 as shown in an enlarged view 110.

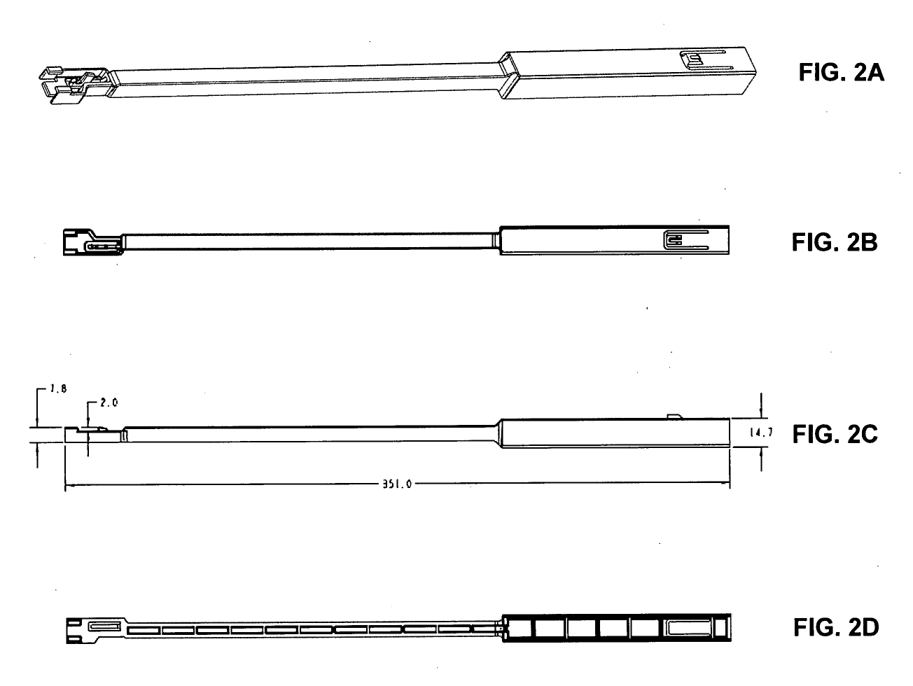

To place or replace a dust cap to an optical connector, the dust cap or tip portion 106 can simply be inverted or rotated in 180 degrees with respect to an axis extended between the tip portion 106 and the backend 108 (e.g., top and bottom surfaces are switched up-side-down). The dust cap can then be reinserted into the tip portion 106 of tool 102. Tool 102 can then be reinserted into the slot of the chassis which pushes the dust cap back into the corresponding optical connector. FIGS. 2A-2D show different views of a tool for removing/replacing and an extender for cleaner according to one embodiment of the invention.

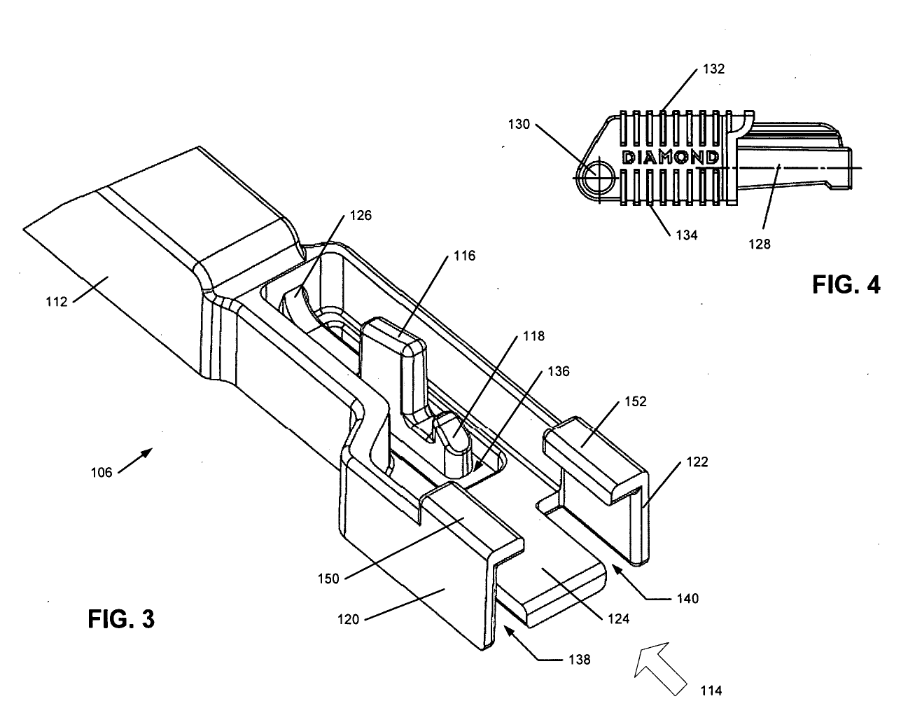

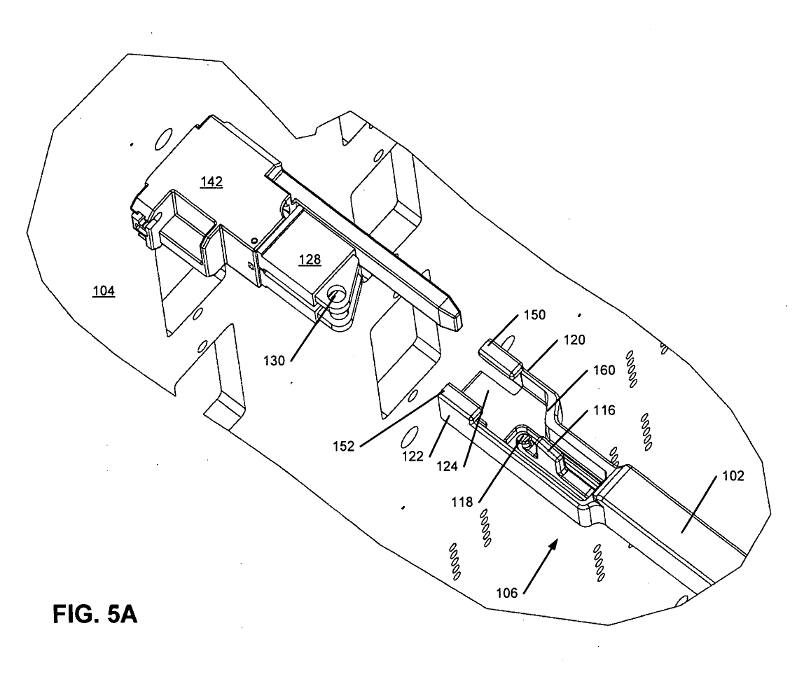

FIG. 3 shows a perspective view of a tip portion of a tool for removing/replacing and an extender for cleaner according to one embodiment of the invention. Referring to FIG. 3, tip portion 106 is disposed and coupled to a frontend of an elongate member 112 which is coupled to a backend of the tool (not shown). In one embodiment, tip portion 106 includes a first side wall 120 and a second side wall 122 coupled to a bottom piece 124 as a base member, forming a tray-like container. The shapes of side walls 120 and 122 may be molded to relatively conform to a shape of a dust cap, such as, for example, dust cap 128 as shown in FIG. 4.

Frontends of side walls 120 and 122 together with a bottom piece 124 form a guide channel to receive a rear end of dust cap 128. Bottom piece 124 includes a tongue portion that is narrower than a rear portion of the bottom piece 124, forming two cutout slots or gap spaces 138 and 140 between tongue portion and side walls 120 and 122. As a result, the tip portions of side walls 120 and 122 can resiliently tilt inwardly and outwardly a little bit for better alignment against edges 132 and 134 of dust cap 128 when dust cap 128 is inserted through a front 114 into the tray. The flexibility of the tip portions of side walls 120 and 122 may also serve as a guide to align a dust cap, particularly, when the dust cap is replaced back into an optical connector on the backplane.

In addition, according to one embodiment, a locking mechanism having a fixed end and a free end is disposed within the tray-like container. In this example, a backend 126 of the locking mechanism is fixedly attached to a back wall of the tray, while a frontend of the locking mechanism remains free. In this example, the frontend of the locking mechanism can tilt freely up and down.

Further, according to one embodiment, bottom piece 124 includes a cutout or window 136 to receive the locking mechanism positioned therein, such that the frontend of the locking mechanism can be tilted up and down within the cutout while a backend 126 of the locking mechanism remains fixedly attached to a back wall of the tray.

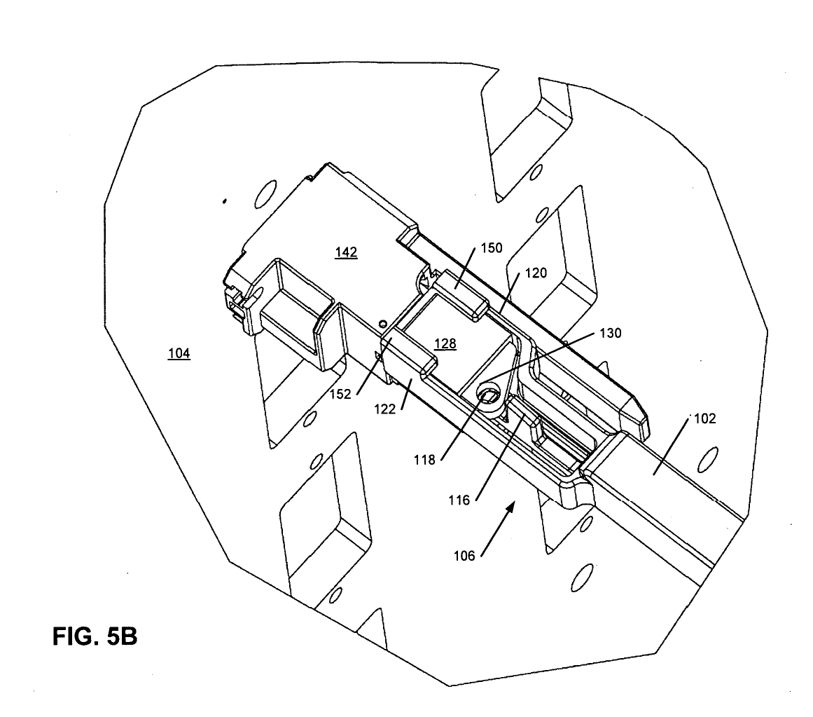

The locking mechanism includes a snap 118 and a release button 116. The snap includes a front surface ramping up from front to rear and a back sharp drop surface. When dust cap 128 is inserted into opening 114, the rear end of dust cap 128 contacts the front surface of snap 118 which in turn pushes the snap 118 moving resiliently down through the cutout 136. When the rear end of dust cap 128 pushed past the back surface of the snap 118, the snap 118 interlocks with hook or snap slot 130 of dust cap 128 by snapping back up through hook 130. As a result, dust cap 128 is interlocked by snap 118 and contained by side wall 120, side wall 122, and bottom wall 124, as shown in FIGS. 5A-5B. Referring to FIGS. 5A-5B, when tool 102 is pulled from optical connector 142 mounted on a backplane of chassis 104, the tool 102 carries the dust cap 128 via the interlocking between snap 118 and hook 130 of dust cap 128. Specifically, the sharp drop surface of snap 118 pulls against the hook 130 of the dust cap away from an optical connector.

Referring back to FIGS. 3-4, once the dust cap 128 has been pulled away from the optical connector, dust cap 128 can be released from the tip portion of the tool 102 by pressing release button 116 downwardly through cutout 136. As a result, snap 118 is disengaged from hook 130 of dust cap 128 and the dust cap 128 can be removed from the tip portion 106 of tool 102.

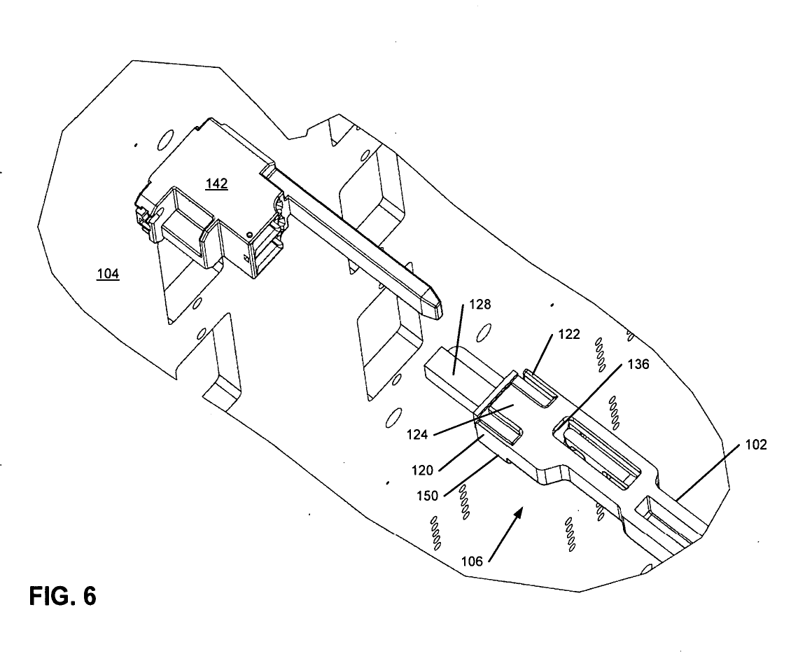

As described above, tool 102 can also be used to place or replace a dust cap back into an optical connector. To place or replace dust cap 128 into an optical connector, tip portion 106 of tool 102 is flipped in 180 degrees with respect to its longitudinal axis while dust cap 128 remains in the same orientation as the one when it is pulled away from the optical connector. For example, when dust cap 128 is pulled away from an optical connector, dust cap 128 is inserted into opening 114 such that edge 132 is against side wall 120 while edge 134 is against side wall 122 in order to align dust cap 128 with tip 106 properly, allowing snap 118 to engage or interlock with hook 130. When dust cap 128 is placed or replaced back into the optical connector, either tool 102 or dust cap 128 needs to be flipped in 180 degrees such that edge 132 is positioned against side wall 122 while edge 134 is positioned against side wall 120 in order to align dust cap 128 with tip 106 properly, preventing snap 118 from being engaged or interlocked with hook 130. Thereafter, dust cap 128 can then be pushed, for example, by wall 160, into the optical connector 142 mounted on backplane 104 as shown in FIG. 6.

According to a further embodiment, the tip portions of side walls 120 and 122 are further extended upwardly and bent into partial top walls 150 and 152, leaving an opening on the top. In this configuration, the partial top walls 150 and 152 can be used as part of a guide member to guide the dust cap being inserted therein. In addition, when the dust cap is replaced back into an optical connector, since tip portion 106 has to be flipped up-side-down in 180 degrees, the partial top walls 150 and 152 would become partial bottom walls which provide support for carrying the dust cap. Note that the configuration in FIG. 3 is shown for purposes of illustration only. Other configurations may also be applied. For example, top walls 150 and 152 can be formed in a complete piece without the top opening (e.g., in a tubular shape). Tip portion 106 can be made from a variety of materials such as plastics or metal.

In addition to be used as a tool for dust cap removal or replacement, as described above, the tool may also be used as a cleaner extender that can extend a cleaner tool in length in order to reach an optical connector mounted on a backplane from a front panel of a network chassis for cleaning purposes without having to remove adjacent circuit packs.

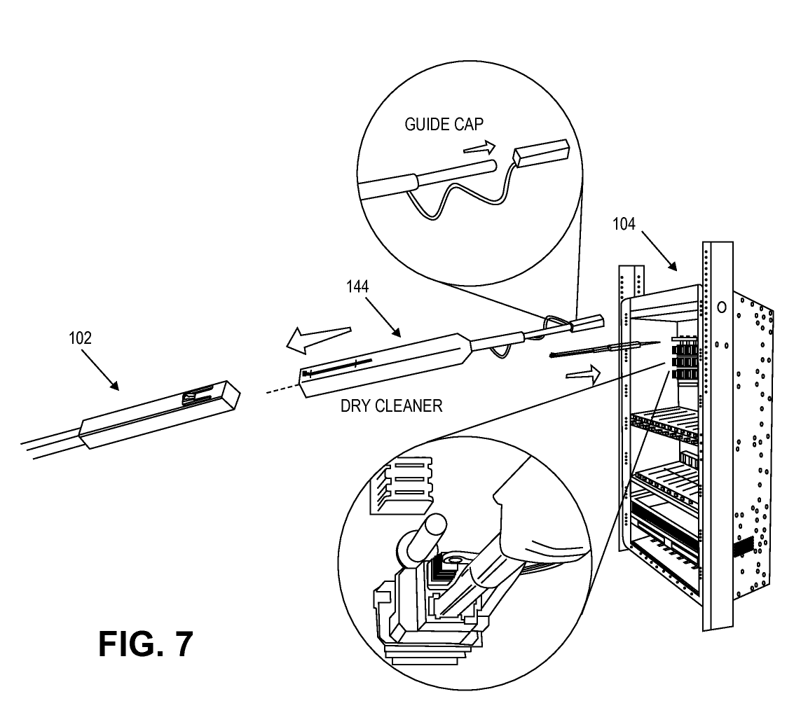

FIG. 7 shows a configuration in which a tool for dust cap removal or replacement can also be used as a cleaner extender according to one embodiment of the invention. Referring to FIG. 7, a backend of a cleaner tool 144 can be attached to a backend of tool 102, which can also be used as a tool for dust cap removal and/or replacement described above. As a result, the cleaner tool 144 is extended in length by attaching its backend handle with a backend handle of tool 102. The extended cleaner tool 144 would be long enough to reach an optical connector mounted on a backplane of chassis 104 without having to remove adjacent circuit packs. Again, note that for the purpose of illustration, certain circuit packs have been removed from chassis 104 in FIG. 7 in order not to unnecessarily obscure embodiments of the invention. However, in practice, the extended cleaner tool can be inserted into any slot to reach a dust cap and/or to clean an optical connector without having to remove the adjacent circuit packs.

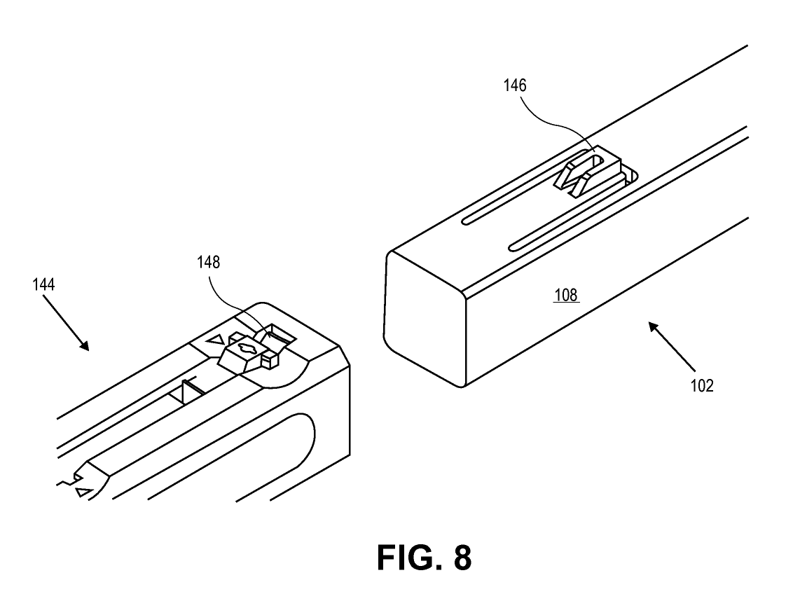

FIG. 8 shows a locking mechanism to extend a cleaner tool using a tool for dust cap removal and replacement according to one embodiment of the invention. Referring to FIG. 8, a backend (e.g., a back handle) of a cleaner tool 144 includes a snap slot 148. Similarly, a backend 108 of tool 102 for dust cap removal and replacement as described above includes a snap button or tab 146. When the backend 108 of the tool 102 is inserted into the backend of cleaner tool 144, snap button 146 snaps up through the snap slot 148 which interlock the tool 102 with cleaner tool 144. In order to detach tool 102 away from cleaner tool, snap button 146 can simply be pressed down through the snap slot 148 while tool 102 is pulled away from cleaner tool 144.

Note that as described above, tool 102 can be used as a dust cap removal and/or replacement tool, as well as an extender for cleaner tool. The tool 102 can be inserted into any slot to reach an optical connector mounted on a backplane of a network chassis without having to remove adjacent circuit packs. According to a further embodiment, prior to inserting tool 102 into a slot, a cleaner guide can be inserted to guide the tool 102 reaching the optical connector. The cleaner guide is designed to have to similar physical dimension as a regular circuit pack which can be inserted to any slot of a chassis. The cleaner guide includes a clean channel or tunnel to allow tool 102 to be inserted therein to reach an optical connector mounted on the backplane without worrying about accidentally contact the adjacent circuit packs. Further detailed information regarding such a cleaner guide can be found in a co-pending U.S. patent application Ser. No. ______, entitled “Cleaner Guide for Cleaning Backplane Optical Connectors”, attorney docket No. 8665P001, which is incorporated by reference herein in its entirety.

Thus, a tool for dust cap removal/replacement and optical cleaner extender has been described herein. In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. An apparatus for removing and replacing a dust cap of a backplane optical connector, the apparatus comprising:
an elongate body having a frontend and a backend; and
a tip member attached to the frontend of the elongate body, the tip member having a locking mechanism disposed thereon,
wherein when the tip member is pushed against a dust cap covering an optical connector mounted on a backplane of a network chassis, the locking mechanism of the tip member interlocks with the dust cap thereby capturing the dust cap for a purpose of removing the dust cap away from the optical connector, and
wherein the elongate body is long enough such that the tip member can be inserted into a slot of the network chassis from a front panel to reach the dust cap of the optical connector mounted on the backplane of the network chassis, without having to remove an adjacent circuit pack of the network chassis.

2. The apparatus of claim 1, wherein when the tip member capturing the dust cap is pulled away from the backplane, the locking mechanism of the tip member carries the dust cap away from the optical connector.

3. The apparatus of claim 1, wherein the locking mechanism includes a snap which when the tip member is pushed against the dust cap, engages with a snap slot disposed on the dust cap for a purpose of interlocking with the dust cap.

4. The apparatus of claim 3, wherein the locking mechanism further comprises a release button which when pressed, causes the snap to be disengaged from the snap slot of the dust cap such that the dust cap can be released from the tip member.

5. The apparatus of claim 4, wherein the tip member includes a first side wall, a second side wall, and a base to form a container having a frontend opening, wherein when the dust cap is inserted into the container through the frontend opening, the snap of the tip member is configured to snap interlock with the snap slot of the dust cap.

6. The apparatus of claim 5, wherein at least one of the first and second side walls is formed to conform to at least one of side surfaces of the dust cap, such that when the dust cap is inserted into the container with a first orientation, the conformed side wall is configured align the snap slot of the dust cap with the snap of the tip member for interlocking.

7. The apparatus of claim 6, wherein if the dust cap is inserted into the container in a second orientation different than the first orientation, the snap of the tip member is not able to interlock with the snap slot of the dust cap.

8. The apparatus of claim 7, wherein when the dust cap is inserted into the tip member with the second orientation, the dust cap can be pushed and replaced back into the optical connector thereby covering the optical connector.

9. The apparatus of claim 5, wherein the tip member includes a back wall mounted on the frontend of the elongate body, wherein the locking mechanism includes a backend fixedly attached to the back wall of the tip member and a frontend remained free such that the frontend of the locking mechanism can freely tilt up and down while the backend of the locking mechanism remains fixedly attached with the back wall of the tip member for a purpose of interlocking with the dust cap.

10. The apparatus of claim 9, wherein the snap is attached on the frontend of the locking mechanism which when the dust cap is inserted into the tip member, the dust cap pushes the frontend of the locking mechanism tilted downwardly until the snap of the locking mechanism snaps back up interlocking with the snap slot of the dust cap.

11. The apparatus of claim 10, wherein the release button is disposed on the locking mechanism which when pressed downwardly, causes the snap of the locking mechanism to tilt downwardly disengaging from the snap slot of the dust cap, such that the dust cap can be removed from the tip member.

12. The apparatus of claim 11, wherein the base of the tip member includes a window cut out underneath the locking mechanism such that when the frontend of the locking mechanism is pressed and tilted downwardly, the frontend of the locking mechanism sinks through the window to allow the snap of the locking mechanism to engage or disengage with the snap slot of the dust cap.

13. The apparatus of claim 7, wherein the tip member further includes a first gap space between a frontend of the first side wall and a frontend of the base, and wherein the tip member further includes a second gap space between a frontend of the second side wall and the frontend of the base, such that the frontends of the first and second side walls can resiliently tilt inwardly and outwardly when the dust cap is inserted into the frontend opening of the tip member.

14. The apparatus of claim 13, wherein the frontends of the first and second side walls serve as a guide to align the dust cap inserted into the tip member through the frontend opening.

15. The apparatus of claim 14, wherein the frontends of the first and second side walls guide the dust cap inserted in a second orientation when the dust cap is pushed and replaced back into the optical connector.

16. The apparatus of claim 15, wherein the frontends of the first and second side walls are designed in a manner such that after the dust cap is pushed and replaced back into the optical connector, the tip member can retreat without pulling the dust cap away from the optical connector.

17. The apparatus of claim 1, wherein the backend of the elongate body is capable of being inserted into a slot of a back handle of a cleaner tool to extend a length of the back handle of the cleaner tool.

18. The apparatus of claim 17, wherein the extended cleaner tool can be inserted from a front panel to reach the optical connector mounted on the backplane of the network chassis for a purpose of cleaning the optical connector.

19. The apparatus of claim 18, wherein the backend of the elongate body further comprises a tab disposed thereon which when the backend of the elongate body is inserted into the slot of the cleaner tool, the tab is snapped into a slot disposed on the back handle of the cleaner tool for interlocking.
